(19) United States
(12) Patent Application Publication
(10) Pub. No.: US 2008/0301505 A1
(43) Pub. Date: Dec. 4, 2008

(54) COMPUTER PERFORMANCE MONITORING METHOD AND SYSTEM

(76) Inventor: Nathan John Harrington, Cary, NC (US)

Correspondence Address: SCHMEISER, OLSEN & WATTS, 22 CENTURY HILL DRIVE, SUITE 302, LATHAM, NY, 12110, US

(21) Appl. No.: 11/755,815

(22) Filed: May 31, 2007

(51) Int. Cl. G06F 11/30; G06F 17/10

(52) U.S. Cl. 714/47; 700/94; 714/E11.024

(57) ABSTRACT

A monitoring method and system. The method includes receiving by a software application within a computing system, data comprising a first data point associated with an operating parameter for a characteristic associated with the computing system. The software application converts the data point into a mathematical value and associates the mathematical value with a scaled value. The software application associates the scaled value with a first timbre and a harmonic interval and generates a first musical note value from the scaled value. The first musical note value is transmitted to an amplifier device within the computing system. The amplifier device generates a first audible musical note from the first musical note value and presents the first audible musical note to a user of the computing system.

### FIELD OF THE INVENTION

The present invention relates to a method and associated system for monitoring computer performance.

### BACKGROUND OF THE INVENTION

Monitoring various internal systems within an electrical device typically comprises a complicated and inefficient process with little flexibility. The electrical device may be prone to failure due to the various internal systems functioning outside of a normal operating range. Accordingly, there exists a need in the art to overcome at least some of the deficiencies and limitations described herein above.

### SUMMARY OF THE INVENTION

The present invention provides a monitoring method comprising:

receiving, by a software application within a computing system, first data comprising a first data point associated with a first operating parameter for a first characteristic associated with said computing system;

converting, by said software application, said first data point into a first mathematical value;

associating, by said software application, said first mathematical value with a first scaled value;

associating, by said software application, said first scaled value with a first timbre and a first harmonic interval;

generating, by said software application, a first musical note value from said first scaled value, said first musical note value comprising said first timbre and said first harmonic interval;

transmitting, by said software application to an amplifier device within said computing system, said first musical note value;

generating, by said amplifier device, a first audible musical note from said first musical note value; and

presenting, by said computing system, said first audible musical note to a user of said computing system, said first musical note comprising said first timbre and said first harmonic interval.

The present invention provides a computing system comprising a processor coupled to a computer-readable memory unit, said memory unit comprising a software application and instructions that when executed by the processor implement a monitoring method, said method comprising:

receiving, by said software application, first data comprising a first data point associated with a first operating parameter for a first characteristic associated with said computing system;

converting, by said software application, said first data point into a first mathematical value;

associating, by said software application, said first mathematical value with a first scaled value;

associating, by said software application, said first scaled value with a first timbre and a first harmonic interval;

generating, by said software application, a first musical note value from said first scaled value, said first musical note value comprising said first timbre and said first harmonic interval;

transmitting, by said software application to an amplifier device within said computing system, said first musical note value;

generating, by said amplifier device, a first audible musical note from said first musical note value; and

presenting, by said computing system, said first audible musical note to a user of said computing system, said first musical note comprising said first timbre and said first harmonic interval.

The present invention provides a process for supporting computer infrastructure, said process comprising providing at least one support service for at least one of creating, integrating, hosting, maintaining, and deploying computer-readable code in a computing system, wherein the code in combination with the computing system is capable of performing a monitoring method, said method comprising:

receiving, by a software application within said computing system, first data comprising a first data point associated with a first operating parameter for a first characteristic associated with said computing system;

converting, by said software application, said first data point into a first mathematical value;

associating, by said software application, said first mathematical value with a first scaled value;

associating, by said software application, said first scaled value with a first timbre and a first harmonic interval;

generating, by said software application, a first musical note value from said first scaled value, said first musical note value comprising said first timbre and said first harmonic interval;

transmitting, by said software application to an amplifier device within said computing system, said first musical note value;

generating, by said amplifier device, a first audible musical note from said first musical note value; and

presenting, by said computing system, said first audible musical note to a user of said computing system, said first musical note comprising said first timbre and said first harmonic interval.

The present invention provides a computer program product, comprising a computer usable medium comprising data and a computer readable program code embodied therein, said computer readable program code adapted to implement a monitoring method within a computing system, said method comprising:

receiving, by a software application within said computing system, first data comprising a first data point associated with a first operating parameter for a first characteristic associated with said computing system;

converting, by said software application, said first data point into a first mathematical value;

associating, by said software application, said first mathematical value with a first scaled value;

associating, by said software application, said first scaled value with a first timbre and a first harmonic interval;

generating, by said software application, a first musical note value from said first scaled value, said first musical note value comprising said first timbre and said first harmonic interval;

transmitting, by said software application to an amplifier device within said computing system, said first musical note value;

generating, by said amplifier device, a first audible musical note from said first musical note value; and

presenting, by said computing system, said first audible musical note to a user of said computing system, said first musical note comprising said first timbre and said first harmonic interval.

The present invention advantageously provides a method and associated system capable of monitoring various internal systems within an electrical device.

### BRIEF DESCRIPTION OF THE DRAWINGS

FIG. 1 illustrates a system for monitoring operating parameters for characteristics for a computing system using audible sounds, in accordance with embodiments of the present invention.

FIG. 2 illustrates an implementation example for using system to monitor operating parameters for characteristics for the computing system of FIG. 1, in accordance with embodiments of the present invention.

FIG. 3 illustrates a flowchart describing an overall algorithm used by the system of FIG. 1 for monitoring operating parameters for characteristics for a computing system using audible sounds, in accordance with embodiments of the present invention.

FIG. 4 illustrates a computer apparatus used for monitoring operating parameters for characteristics for a computing apparatus/system using audible sounds, in accordance with embodiments of the present invention.

### DETAILED DESCRIPTION OF THE INVENTION

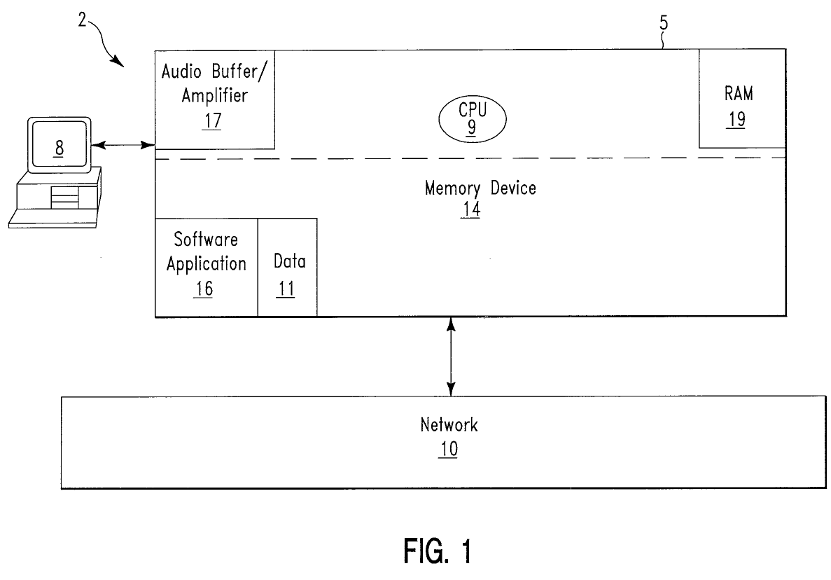

FIG. 1 illustrates a system 2 for monitoring operating parameters for characteristics for a computing system 5 using audible sounds, in accordance with embodiments of the present invention. The audible sounds used to monitor the operating parameters for characteristics for computing system 5 include the use of tone, timbre, and harmony. The parameters for the characteristics monitored and presented to a user (i.e., describing an overall status of computing system 5) via audible sounds may include, inter alia, central processing unit (CPU) percent usage, random access memory (RAM) utilization percentage, disk drive (hard disc, CDROM, etc) utilization percentage, network utilization percentage, cache utilization percentage, etc.

System 2 comprises a computing system 4 (e.g., a personal computer) connected to a network 10. Network 10 may comprise any type of network known to a person of ordinary skill in the art including, inter alia, a local area network, (LAN), a wide area network (WAN), the Internet, etc. Computing system 4 comprises an input/output (I/O) interface 8, a CPU 9, a memory device 14, RAM 19, and an audio buffer/amplifier 17. The I/O interface 8 may comprise, inter alia, a keyboard, a video monitor, a speaker, etc. Memory device 14 may comprise a hard disc drive, a CD ROM drive, etc. Memory device 14 comprises a software application 16 and input data 11. Input data 11 may comprise any data required to associate operating parameters for the performance characteristics for computing system 5 with audible sounds.

Software application 16 may include a software synthesizer (e.g., a midi synthesizer) for generating the audible sounds. Software application 16 is configured to generate the audible sounds associated with the performance characteristics for computing system 5. Software application 16 uses tone, timbre and harmony to present easily discernable information about the operation of a complex mix of data points associated with the operating parameters for characteristics associated with computing system 5. Note that software application 16 may be used to monitor any system with multiple data points collected to relay information to a user about the overall status of the system. Software application 16 first acquires information (i.e., data points) about the various operating parameters for characteristics of computing system 5. For example, network 10 utilization percentage, CPU 9 percent usage, RAM 19 utilization percentage, and disk utilization percentage, etc. is gathered. This information is mathematically transformed into a value between a minimum of 0 and maximum of 100. This 0-100 value is then modified into a single level on a 12-note interval and played through a software synthesizer. For example, a value between 0 and 8 on the 0-100 scale will be transformed to a note velocity of 12 and played by the synthesizer. The note velocity of 12 is a standard midi synthesizer description of a note corresponding roughly to a low C on a piano keyboard. For each data value (i.e., associated with the operating parameters for characteristics associated with computing system 5) acquired:

1. The 0-100 scaling process is performed.
2. The 12 note interval scaling process is performed
3. A timbre selection (i.e., musical instrument voice) process is performed.
4. A harmonic interval selection process is performed.
5. The associated musical note is synthesized and played for a user through a speaker system (i.e., I/O interface 8).

The harmonic interval is a simple 1 octave progression in the above described invention, but may comprise any combination designed to relay information. For example, software application 16 may switch to a minor key when an error is detected or one of the usage data points is at 100 (full utilization).

Software application 16 uses tone, timbre, and harmony to relay information to a user about the overall status of computing system 5. For example, if software application 16 monitors CPU 9 percent usage, every value on the CPU 9 percent usage scale is processed and a synthesized note is generated (i.e., for every value) with the appropriate characteristics to represent the monitored component's (e.g., the CPU 9) status. If CPU 9 percent usage is at 75%, a piano note that is 8 levels above middle C (i.e., 261.2 hz) will be generated. Software application 16 will assign one timbre (e.g., a piano) to a data acquisition point (i.e., one data point representing usage) and modulate a pitch through note synthesis based on the value of the collected data point. For example, as the CPU 9 percent usage increases, a frequency of the note will increase thereby providing an easily recognizable interface to the status change of the computing device. As an example, software application 16 may use the following conditions listed in table 1 to monitor various operating parameters:

TABLE 1

| | |
|---|---|
| CPU percent usage: | Piano 12, 1-octave increments |
| RAM utilization percentage: | Organ 12, 1-octave increments |
| Network utilization percentage: | Dulcimer 12, 1-octave increments |
| Disk utilization percentage: | Strings 12, 1-octave increments |

As illustrated in table 1, a user is only required to know the representative meanings of four different classes of sounds. The various notes played according the data acquisition channels will increase or decrease in frequency and the user will be able monitor the associated expenditure of each resource based on the synthesized note's frequency. An additional channel of information may be introduced by altering an interval between the synthesized notes based on secondary data characteristics. If the RAM usage component is 50%, but there have been memory errors detected, software application 16 may synthesize a note of “middle C”+3 levels up, to produce a harmonic dissonance with its neighboring notes synthesized for CPU, network, and disk utilization percentage. The above description illustrates how modifying the pitch of synthesized note produces an easily recognizable change in informational content.

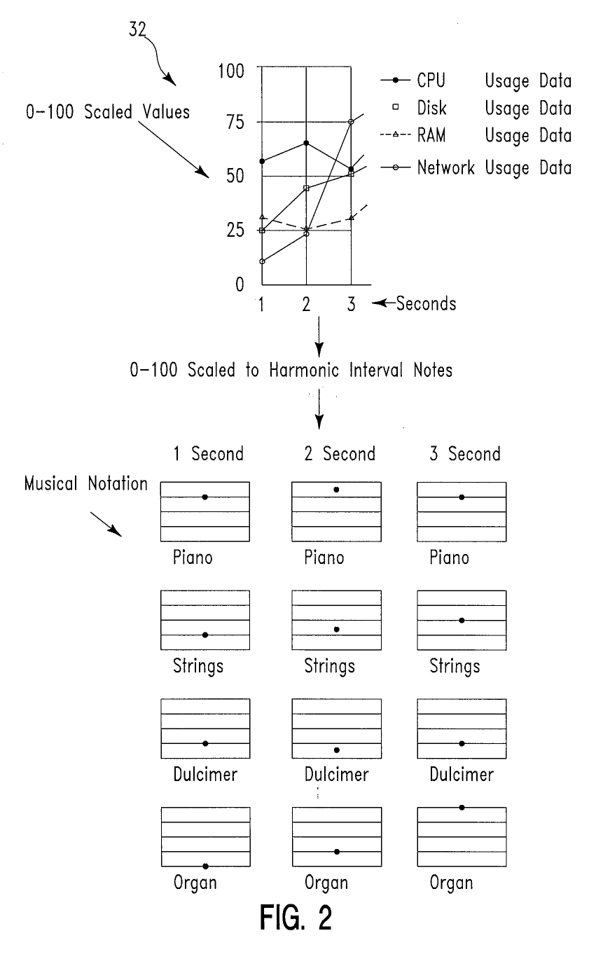

FIG. 2 illustrates an implementation example for using system 2 to monitor operating parameters for characteristics for computing system 5 of FIG. 1, in accordance with embodiments of the present invention. FIG. 2 illustrates a graph 32 of 0-100 scaled values and how they are transformed to musical tones as represented on a standard sheet music type display 37. FIG. 2 illustrates how the various data points are transformed into different notes using different timbres (piano, strings, etc.) and then simultaneously synthesized and played through audio buffer/amplifier 17 in FIG. 1. Using the above described process, each second of audio contains notes from each of the selected data points and the user may discern the performance of computing system 5 by the tone, timbre, and harmony of the audio output (i.e., via I/O device 8). System 2 uses software application 16 for simple system status monitoring. Software application 16 may provide three forms of CPU load, generalized disk blocks in and out, and the capability for monitoring many other system functions.

As a first example, if the CPU percent usage data is viewed individually in graph 32, the usage values range from approximately 55 to 67 to 50. These data points are acquired from a performance monitoring system of computing system 5. For example, CPU percent usage information may be printed out once per second. The CPU information may be printed out directly as a value between 0 and 100, where 100 describes a maximum utilization for the CPU. Software application then takes the 0-100 value and divides the value by 12 to produce a value that will fall into one of eight zones. These eight zones correspond to notes on a scale and are sent to audio buffer/amplifier 17.

For example, the first value of 55 is divided by 12 to produce a whole integer value of 5 (i.e., 4.583 rounded up). This value is then multiplied by 12 to ensure it falls into one of the 8 zones for note generation. This process effectively changes a value on a 0-100 scale into one of 8 values, 0 12 24 36 48 60 72 84 96. These values are then passed to a software synthesizer within software application 16 to generate musically recognizable notes based on the values passed in. For the first data point, the value is 55/12=5, which is then multiplied by 12 resulting in a value of 60; The value of 60 is then passed to the software synthesizer in order to generate the appropriate musical note. For the next data point value (i.e., 67), the 67 value is transformed into 67/12=6 which is then multiplied by 12 to comprise a 72 zone value. This 72 is then passed to the software synthesizer which plays a note one octave higher than the 60 zone note played 1 second earlier.

As a second example, if the disk usage data is viewed individually in graph 32, the first usage value of 25 will be transformed into 25/12=2 (rounded down). This value is then multiplied by 12 in order to fit into one of the eight zones, making the note to be generated a 24. Software synthesizers (e.g., midi synthesizer) will use this 24 value as a specified note velocity (roughly equivalent to a position on a scale) when playing the specified note. A second usage value of 40 will be transformed into 40/12=3 (rounded down), and then multiplied by 12 in order to fit into the 36 zone.

For a combined CPU/disk usage example, the notes will be gradually higher for both the CPU percent usage and disk utilization percentage over the first two seconds of monitored data. This increase in note value will indicate to the user that percent usage of the CPU percent usage and utilization percentage of the disk subsystems have increased and the precise note values will indicate to the user how much of the resource has been utilized.

For example, if computing system 5 is in a base state (e.g., viewing desktop icons with no software applications running), the system 2 will emit 4 distinct low tones that indicate the various component resource utilizations of computing system 5. When the user starts a program (e.g., a word processor program), the disk and CPU usage data points will increase, and a subsequent pitch of notes played will increase to indicate to the user that those components are being utilized. After the program loads and is no longer consuming system resources, the pitch of the notes will decrease to indicate less of a load on computing system 5 to the user.

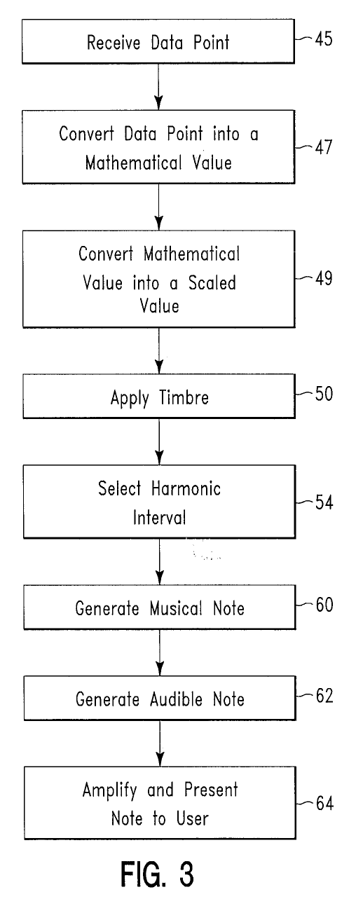

FIG. 3 illustrates a flowchart describing an overall algorithm used by system 2 of FIG. 1 for monitoring operating parameters for characteristics for a computing system 5 using audible sounds, in accordance with embodiments of the present invention. In step 45, a data point indicating an operating parameter for an operating characteristic associated with a computing system (e.g., computing system 5 of FIG. 1) is retrieved. For example, an operating characteristic may comprise, inter alia, network usage, CPU percent usage, RAM utilization percentage, disk drive utilization percentage, etc. In step 47, the data point is converted into a mathematical value. The data point may be mathematically transformed into a value between a minimum of 0 and maximum of 100. In step 49, the mathematical value is converted into a scaled value. The mathematical value may be modified into a single level on a 12-note interval. For example, a mathematical value of between 0 and 8 on the 0-100 scale may be transformed to a note velocity of 12. In step 50, the scaled value is associated with a timbre. In step 54, the scaled value associated with the timbre is associated with a first harmonic interval. In step 60, the scaled value is converted into a musical note value comprising the timbre and harmonic interval. In step 62, an audible musical note is generated from the musical note value generated in step 60. In step 64, the audible musical note is amplified and presented to a user of the computing system and the process is repeated.

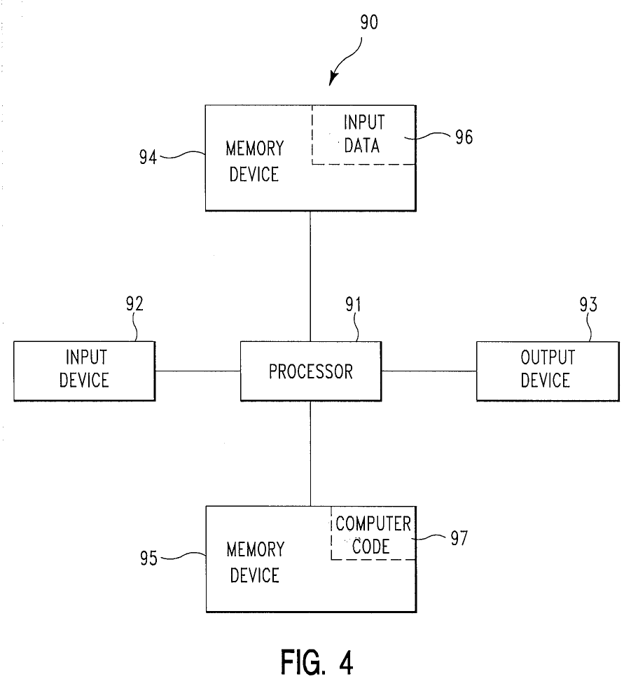

FIG. 4 illustrates a computer apparatus 90 (e.g., computing system 5 of FIG. 1) used for monitoring operating parameters for characteristics for a computing apparatus/system using audible sounds, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 3) for allowing a user to monitor operating parameters for characteristics for a computing apparatus/system using audible sounds. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 4) may comprise the algorithm of FIG. 3 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Still yet, any of the components of the present invention could be deployed, managed, serviced, etc. by a service provider who offers to allow a user monitor operating parameters for characteristics for a computing apparatus/system using audible sounds. Thus the present invention discloses a process for deploying or integrating computing infrastructure, comprising integrating computer-readable code into the computer system 90, wherein the code in combination with the computer system 90 is capable of performing a method for monitoring operating parameters for characteristics for a computing apparatus/system using audible sounds. In another embodiment, the invention provides a business method that performs the process steps of the invention on a subscription, advertising, and/or fee basis. That is, a service provider, such as a Solution Integrator, could offer to allow a user to monitor operating parameters for characteristics for a computing apparatus/system using audible sounds. In this case, the service provider can create, maintain, support, etc. a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 4 shows the computer system 90 as a particular configuration of hardware and software, any configuration of hardware and software, as would be known to a person of ordinary skill in the art, may be utilized for the purposes stated supra in conjunction with the particular computer system 90 of FIG. 4. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A monitoring method comprising:
receiving, by a software application within a computing system, first data comprising a first data point associated with a first operating parameter for a first characteristic associated with said computing system;
converting, by said software application, said first data point into a first mathematical value;
associating, by said software application, said first mathematical value with a first scaled value;
associating, by said software application, said first scaled value with a first timbre and a first harmonic interval;
generating, by said software application, a first musical note value from said first scaled value, said first musical note value comprising said first timbre and said first harmonic interval;
transmitting, by said software application to an amplifier device within said computing system, said first musical note value;
generating, by said amplifier device, a first audible musical note from said first musical note value; and
presenting, by said computing system, said first audible musical note to a user of said computing system, said first musical note comprising said first timbre and said first harmonic interval.

2. The method of claim 1, further comprising:
receiving, by said software application, second data comprising a second data point associated with said first operating parameter for said first characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

3. The method of claim 1, further comprising:
receiving, by said software application, second data comprising a second data point associated with a second operating parameter for a second characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

4. The method of claim 1, wherein said generating said first musical note value from said first scaled value comprises synthesizing said first scaled value to generate said first musical note value.

5. The method of claim 4, wherein said software application comprises a midi synthesizer software module, and wherein said synthesizing is performed by said midi synthesizer software module.

6. The method of claim 1, wherein said first characteristic associated with said computing system comprises a computer characteristic selected from the group consisting of computer network utilization percentage, central processing unit (CPU) percent usage for said computing system, and computer readable memory unit utilization percentage for said computing system.

7. A computing system comprising a processor coupled to a computer-readable memory unit, said memory unit comprising a software application and instructions that when executed by the processor implement a monitoring method, said method comprising:
receiving, by said software application, first data comprising a first data point associated with a first operating parameter for a first characteristic associated with said computing system;
converting, by said software application, said first data point into a first mathematical value;
associating, by said software application, said first mathematical value with a first scaled value;
associating, by said software application, said first scaled value with a first timbre and a first harmonic interval;
generating, by said software application, a first musical note value from said first scaled value, said first musical note value comprising said first timbre and said first harmonic interval;
transmitting, by said software application to an amplifier device within said computing system, said first musical note value;
generating, by said amplifier device, a first audible musical note from said first musical note value; and
presenting, by said computing system, said first audible musical note to a user of said computing system, said first musical note comprising said first timbre and said first harmonic interval.

8. The computing system of claim 7, wherein said method further comprises:
receiving, by said software application, second data comprising a second data point associated with said first operating parameter for said first characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

9. The computing system of claim 7, wherein said method further comprises:
receiving, by said software application, second data comprising a second data point associated with a second operating parameter for a second characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

10. The computing system of claim 7, wherein said generating said first musical note value from said first scaled value comprises synthesizing said first scaled value to generate said first musical note value.

11. The computing system of claim 10, wherein said software application comprises a midi synthesizer software module, and wherein said synthesizing is performed by said midi synthesizer software module.

12. The computing system of claim 7, wherein said first characteristic associated with said computing system comprises a computer characteristic selected from the group consisting of computer network utilization percentage, central processing unit (CPU) percent usage for said computing system, and computer readable memory unit utilization percentage for said computing system.

13. A process for supporting computer infrastructure, said process comprising providing at least one support service for at least one of creating, integrating, hosting, maintaining, and deploying computer-readable code in a computing system, wherein the code in combination with the computing system is capable of performing a monitoring method, said method comprising:
receiving, by a software application within said computing system, first data comprising a first: data point associated with a first operating parameter for a first characteristic associated with said computing system;
converting, by said software application, said first data point into a first mathematical value;
associating, by said software application, said first mathematical value with a first scaled value;
associating, by said software application, said first scaled value with a first timbre and a first harmonic interval;
generating, by said software application, a first musical note value from said first scaled value, said first musical note value comprising said first timbre and said first harmonic interval;
transmitting, by said software application to an amplifier device within said computing system, said first musical note value;
generating, by said amplifier device, a first audible musical note from said first musical note value; and
presenting, by said computing system, said first audible musical note to a user of said computing system, said first musical note comprising said first timbre and said first harmonic interval.

14. The process of claim 13, wherein said method further comprises:
receiving, by said software application, second data comprising a second data point associated with said first operating parameter for said first characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

15. The process of claim 13, wherein said method further comprises:
receiving, by said software application, second data comprising a second data point associated with a second operating parameter for a second characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

16. The process of claim 13, wherein said generating said first musical note value from said first scaled value comprises synthesizing said first scaled value to generate said first musical note value.

17. The process of claim 16, wherein said software application comprises a midi synthesizer software module, and wherein said synthesizing is performed by said midi synthesizer software module.

18. The process of claim 13, wherein said first characteristic associated with said computing system comprises a computer characteristic selected from the group consisting of computer network utilization percentage, central processing unit (CPU) percent usage for said computing system, and computer readable memory unit utilization percentage for said computing system.

19. A computer program product, comprising a computer usable medium comprising data and a computer readable program code embodied therein, said computer readable program code adapted to implement a monitoring method within a computing system, said method comprising:
receiving, by a software application within said computing system, first data comprising a first data point associated with a first operating parameter for a first characteristic associated with said computing system;
converting, by said software application, said first data point into a first mathematical value;
associating, by said software application, said first mathematical value with a first scaled value;
associating, by said software application, said first scaled value with a first timbre and a first harmonic interval;
generating, by said software application, a first musical note value from said first scaled value, said first musical note value comprising said first timbre and said first harmonic interval;
transmitting, by said software application to an amplifier device within said computing system, said first musical note value;
generating, by said amplifier device, a first audible musical note from said first musical note value; and
presenting, by said computing system, said first audible musical note to a user of said computing system, said first musical note comprising said first timbre and said first harmonic interval.

20. The computer program product of claim 19, wherein said method further comprises:
receiving, by said software application, second data comprising a second data point associated with said first operating parameter for said first characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

21. The computer program product of claim 19, wherein said method further comprises:
receiving, by said software application, second data comprising a second data point associated with a second operating parameter for a second characteristic associated with said computing system;
converting, by said software application, said second data point into a second mathematical value;
associating, by said software application, said second mathematical value with a second scaled value;
associating, by said software application, said second scaled value with a second timbre and a second harmonic interval;
generating, by said software application, a second musical note value from said second scaled value, said second musical note value different from said first musical note value, said second musical note value comprising said second timbre and said second harmonic interval;
transmitting, by said software application to said amplifier device within said computing system, said second musical note value;
generating, by said amplifier device, a second audible musical note from said second musical note value, said second audible musical note different from said first audible musical note; and
presenting, by said computing system, said second audible musical note to said user of said computing system, said second musical note comprising said second timbre and said second harmonic interval.

22. The computer program product of claim 19, wherein said generating said first musical note value from said first scaled value comprises synthesizing said first scaled value to generate said first musical note value.

23. The computer program product of claim 22, wherein said software application comprises a midi synthesizer software module, and wherein said synthesizing is performed by said midi synthesizer software module.

24. The computer program product of claim 19, wherein said first characteristic associated with said computing system comprises a computer characteristic selected from the group consisting of computer network utilization percentage, central processing unit (CPU) percent usage for said computing system, and computer readable memory unit utilization percentage for said computing system.
